(19) United States
(12) Patent Application Publication
(10) Pub. No.: US 2023/0061623 A1
(43) Pub. Date: Mar. 2, 2023

(54) POWER STORAGE DEVICE

(71) Applicant: Prime Planet Energy & Solutions, Inc., Tokyo (JP)

(72) Inventor: Yasuaki UEMURA, Kakogawa-shi (JP)

(21) Appl. No.: 17/893,078

(22) Filed: Aug. 22, 2022

(30) Foreign Application Priority Data
Aug. 30, 2021 (JP) 2021-139888

(51) Int. Cl. H01M 10/6554; H01M 10/613

(52) U.S. Cl. CPC H01M 10/6554; H01M 10/613

(57) ABSTRACT

A power storage device includes: a plurality of power storage cells each including a case having a substantially rectangular parallelepiped shape with a bottom surface, the plurality of power storage cells being stacked along a first direction; a cooling plate provided on the bottom surface of the case in each of the plurality of power storage cells; and a heat transfer member provided between the bottom surface of the case and the cooling plate. The cooling plate is provided with a recess along deformation of the bottom surface of the case in a second direction orthogonal to the first direction.

This nonprovisional application is based on Japanese Patent Application No. 2021-139888 filed on Aug. 30, 2021, with the Japan Patent Office, the entire contents of which are hereby incorporated by reference.

### BACKGROUND OF THE INVENTION

### Field of the Invention

The present technology relates to a power storage device.

### Description of the Background Art

Japanese National Patent Publication No. 2019-503040 illustrates that a groove corresponding to each of cells is provided in a cooling plate so as to increase a contact area between the battery cell and the cooling plate.

In the structure described in Japanese National Patent Publication No. 2019-503040, the stack of the battery cells cannot be compressed with the battery cells being placed on the cooling plate. This can lead to increased manufacturing cost of a battery pack.

### SUMMARY OF THE INVENTION

An object of the present technology is to provide a power storage device to attain both reduction in manufacturing cost and improvement in cooling performance.

A power storage device according to the present technology includes: a plurality of power storage cells each including a case having a substantially rectangular parallelepiped shape with a bottom surface, the plurality of power storage cells being stacked along a first direction; a cooling plate provided on the bottom surface of the case in each of the plurality of power storage cells; and a heat transfer member provided between the bottom surface of the battery case and the cooling plate. The cooling plate is provided with a recess along deformation of the bottom surface of the case in a second direction orthogonal to the first direction.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing a basic configuration of a battery pack.

FIG. 2 is a diagram showing battery cells and end plates in the battery pack shown in FIG. 1.

FIG. 3 is a diagram showing a battery cell in the battery pack shown in FIG. 1.

FIG. 4 is a diagram showing a shape of a cooling plate according to one embodiment.

FIG. 5 is a diagram showing a shape of a cooling plate according to a comparative example.

FIG. 6 is a diagram showing a shape of a cooling plate according to a modification.

FIG. 7 is a diagram schematically showing a battery cell according to one example.

### DESCRIPTION OF THE PREFERRED EMBODIMENTS

Hereinafter, embodiments of the present technology will be described. It should be noted that the same or corresponding portions are denoted by the same reference characters, and may not be described repeatedly.

It should be noted that in the embodiments described below, when reference is made to number, amount, and the like, the scope of the present technology is not necessarily limited to the number, amount, and the like unless otherwise stated particularly. Further, in the embodiments described below, each component is not necessarily essential to the present technology unless otherwise stated particularly. Further, the present technology is not limited to one that necessarily exhibits all the functions and effects stated in the present embodiment.

It should be noted that in the present specification, the terms “comprise”, “include”, and “have” are open-end terms. That is, when a certain configuration is included, a configuration other than the foregoing configuration may or may not be included.

Also, in the present specification, when geometric terms and terms representing positional/directional relations are used, for example, when terms such as “parallel”, “orthogonal”, “obliquely at 45°”, “coaxial”, and “along” are used, these terms permit manufacturing errors or slight fluctuations. In the present specification, when terms representing relative positional relations such as “upper side” and “lower side” are used, each of these terms is used to indicate a relative positional relation in one state, and the relative positional relation may be reversed or turned at any angle in accordance with an installation direction of each mechanism (for example, the entire mechanism is reversed upside down).

In the present specification, the term “battery” is not limited to a lithium ion battery, and may include another battery such as a nickel-metal hydride battery. In the present specification, the term “electrode” may collectively represent a positive electrode and a negative electrode. Further, the term “electrode plate” may collectively represent a positive electrode plate and a negative electrode plate.

In the present specification, when the term “power storage cell” or “power storage device” is used, the term “power storage cell” or “power storage device” is not limited to a battery cell or a battery module, and may include, for example, a capacitor.

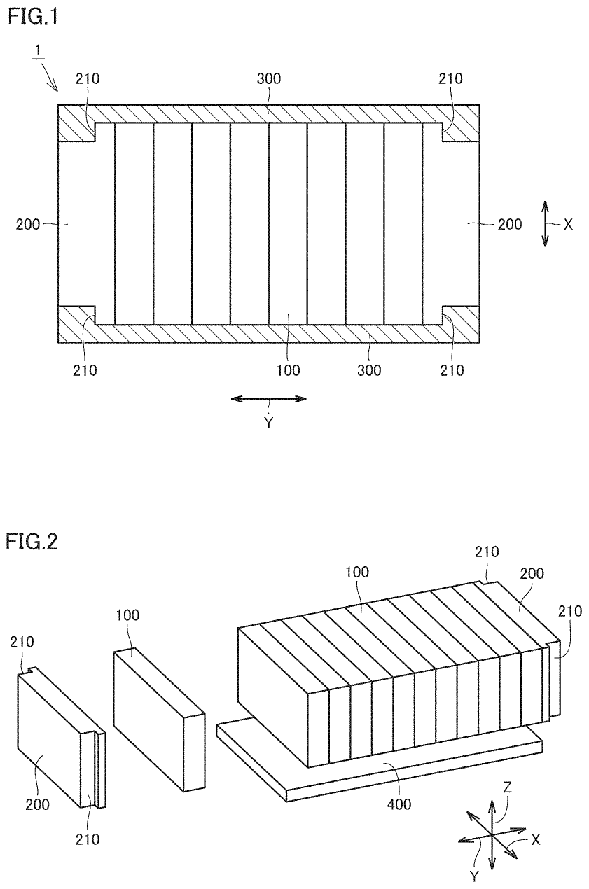

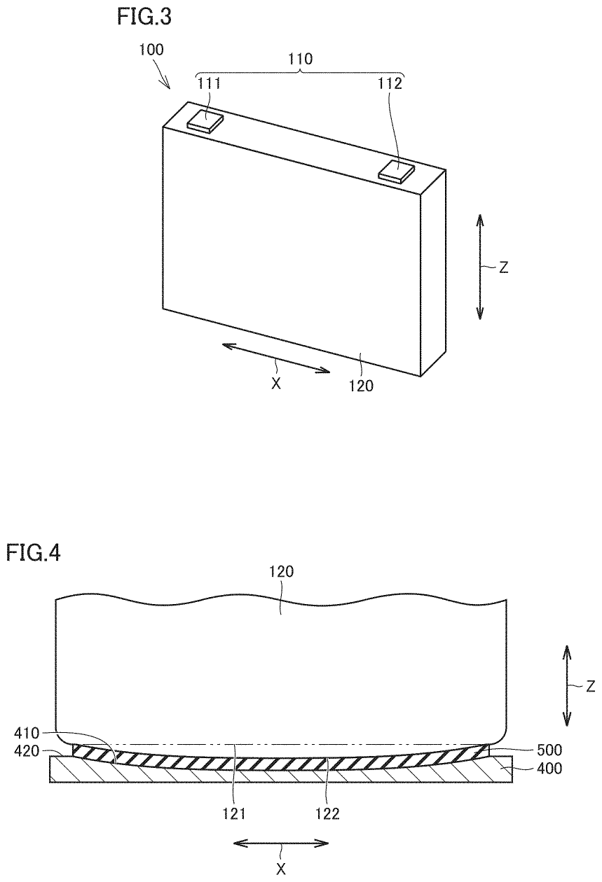

FIG. 1 is a diagram showing a basic configuration of a battery pack 1. FIG. 2 is a diagram showing battery cells 100 and end plates 200 included in battery pack 1. FIG. 3 is a diagram showing battery cell 100 in battery pack 1.

As shown in FIGS. 1 and 2, battery pack 1, which serves as an exemplary “power storage module”, includes battery cells 100, end plates 200, a restraint member 300, and a cooling plate 400.

The plurality of battery cells 100 are provided side by side in a Y axis direction (first direction). Each of battery cells 100 includes an electrode terminal 110. A separator (not shown) is interposed between the plurality of battery cells 100. The plurality of battery cells 100, which are sandwiched between two end plates 200, are pressed by end plates 200, and are therefore restrained between two end plates 200.

End plates 200 are disposed beside both ends of battery pack 1 in the Y axis direction. Each of end plates 200 is fixed to a base such as a case that accommodates battery pack 1. Stepped portions 210 are formed at both ends of end plate 200 in an X axis direction. Stepped portions 210 are formed to extend in a Z axis direction. The X axis direction, the Y axis direction, and the Z axis direction are orthogonal to one another.

End plate 200 is composed of aluminum or cast iron, for example. The material of end plate 200 is not limited to these.

Restraint member 300 connects two end plates 200 to each other. Restraint member 300 is attached to stepped portions 210 formed on two end plates 200.

Restraint member 300 is engaged with stepped portions 210 with compression force in the Y axis direction being exerted to the stack of the plurality of battery cells 100 and end plates 200, and then the compression force is released, with the result that tensile force acts on restraint member 300 that connects two end plates 200 to each other. As a reaction thereto, restraint member 300 presses two end plates 200 in directions of bringing them closer to each other.

Restraint member 300 is composed of aluminum, iron, or stainless steel, for example. The material of restraint member 300 is not limited to these.

Cooling plate 400 is provided on the bottom surfaces of the plurality of battery cells 100. Cooling plate 400 is composed of a metal or the like excellent in heat transfer property. As an example, cooling plate 400 is constituted of an extruded material composed of aluminum. Cooling plate 400 promotes heat dissipation from battery cell 100. A flow path may be provided inside cooling plate 400 to allow a cooling medium to flow through the flow path in order to further increase cooling performance.

As shown in FIG. 3, battery cell 100 is formed to have a substantially rectangular parallelepiped shape with a flat surface. Electrode terminal 110 includes a positive electrode terminal 111 and a negative electrode terminal 112. Positive electrode terminal 111 and negative electrode terminal 112 are arranged side by side in the X axis direction (second direction). Electrode terminal 110 is provided on the upper surface of a housing 120 (case) having a prismatic shape. Each of the upper surface and the bottom surface of housing 120 has a substantially rectangular shape in which the X axis direction corresponds to a long side direction and the Y axis direction corresponds to a short side direction. An electrode assembly and an electrolyte solution are accommodated in housing 120.

When manufacturing battery pack 1, first, the plurality of battery cells 100 are stacked along the Y axis direction. Next, end plates 200 are provided at both ends of stacked battery cells 100. The plurality of battery cells 100 and end plates 200 are restrained in the Y axis direction by restraint member 300. Cooling plate 400 may be assembled before the plurality of battery cells 100 are restrained or may be assembled after the plurality of battery cells 100 are restrained.

FIG. 4 is a diagram showing the shape of cooling plate 400 according to the present embodiment. As shown in FIG. 4, the bottom surface of housing 120 of battery cell 100 has an ideal line 121 and a deformation line 122. Ideal line 121 means a line of a flat surface maintained by the bottom surface of housing 120 in a state in which housing 120 accommodates no electrode assembly and no electrolyte solution (or a state in which housing 120 accommodates the electrode assembly and the electrolyte solution but the bottom surface of housing 120 is not bulged due to gas or the like). Deformation line 122 means a line of the bottom surface of housing 120 in a state in which housing 120 accommodates the electrode assembly and the electrolyte solution and the bottom surface of housing 120 is bulged due to gas or the like.

A heat transfer member 500 is provided between the bottom surface of housing 120 and cooling plate 400. As heat transfer member 500, for example, a silicone-based heat radiation sheet, a heat radiation gel, or the like is used. As the heat radiation gel, a filling type heat radiation gel or coating type heat radiation gel is used.

Cooling plate 400 is provided with a recess 410 along deformation line 122 of the bottom surface of housing 120 in the X axis direction. In the X axis direction, the edge ends of recess 410 of cooling plate 400 and the edge ends of heat transfer member 500 substantially coincide with each other. Thus, by extending heat transfer member 500 to the edge ends of recess 410, heat dissipation efficiency of battery cell 100 can be improved.

Cooling plate 400 has a flat surface 420 located outside recess 410 in the X axis direction. Cooling plate 400 is located on the lower side with respect to ideal line 121 of the bottom surface of housing 120. By forming flat surface 420 in cooling plate 400 outside recess 410 and positioning cooling plate 400 on the lower side with respect to ideal line 121 of the bottom surface of housing 120, the thickness of cooling plate 400 is suppressed from being increased excessively, thereby attaining weight reduction of battery pack 1.

The shape of recess 410 can be changed as appropriate. As an example, recess 410 includes an arc shape.

FIG. 5 is a diagram showing a shape of a cooling plate 400A according to a comparative example. As shown in FIG. 5, the entire upper surface of cooling plate 400A according to the comparative example is formed to be flat. Therefore, a bulging amount of housing 120 of battery cell 100 (difference between ideal line 121 and deformation line 122 in FIG. 5) needs to be absorbed by deformation of heat transfer member 500. As a result, it is necessary to increase the thickness of heat transfer member 500 as compared with the example of FIG. 4.

On the other hand, since recess 410 is formed in cooling plate 400 according to the present embodiment along deformation line 122 of the bottom surface of housing 120, the bulging amount of housing 120 does not need to be absorbed by deformation of heat transfer member 500, with the result that heat transfer member 500 can be formed to be thin accordingly. As a result, the heat radiation efficiency of battery cell 100 can be improved, the weight of battery pack 1 can be reduced, and the manufacturing cost of battery pack 1 can be reduced.

Housing 120 of battery cell 100 is placed on cooling plate 400 with heat transfer member 500 being placed in recess 410. On this occasion, it is required to suppress positional displacement of heat transfer member 500.

A low friction layer having a relatively small friction coefficient may be provided between the bottom surface of housing 120 and heat transfer member 500. The low friction layer is constituted of, for example, a PET resin layer or the like. Further, an uneven portion (grip portion) for increasing frictional resistance between cooling plate 400 and heat transfer member 500 may be provided between cooling plate 400 and heat transfer member 500. With these configurations, positional displacement of heat transfer member 500 can be effectively suppressed.

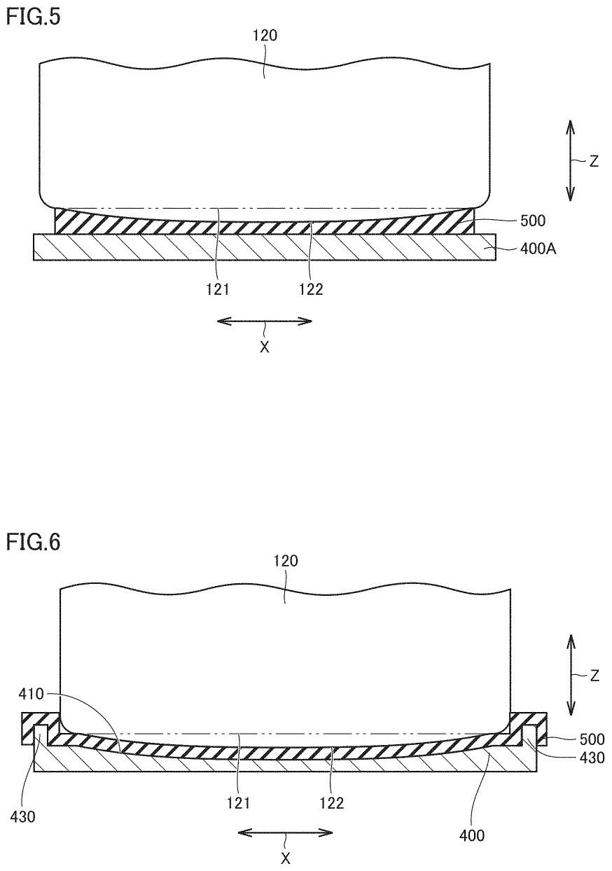

FIG. 6 is a diagram showing a shape of a cooling plate 400 according to a modification. As shown in FIG. 6, cooling plate 400 according to the modification has protrusions 430 each protruding on the upper side with respect to ideal line 121 of the bottom surface of housing 120. Heat transfer member 500 extends to the outer side with respect to each of protrusions 430 in the X axis direction. In this way, positional displacement of heat transfer member 500 can be effectively suppressed.

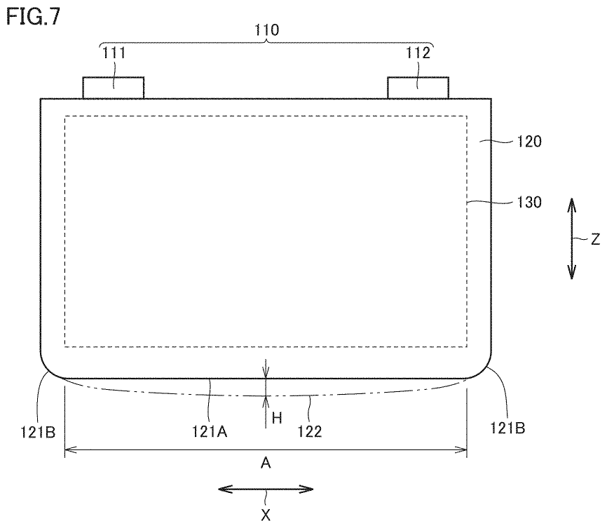

FIG. 7 is a diagram schematically showing a battery cell 100 according to an example. As shown in FIG. 7, ideal line 121 of the bottom surface of housing 120 includes: a flat surface portion 121A located on the center side in the X axis direction; and curved surface portions 121B (curvature portions) located on both end sides in the X axis direction. Heat transfer member 500 is provided to have a width as large as a width A of flat surface portion 121A in the X axis direction, i.e., heat transfer member 500 is provided such that the edge ends of heat transfer member 500 and the edge ends of flat surface portion 121A substantially coincide with each other.

As an example, the width (A in FIG. 7) of flat surface portion 121A in the X axis direction is 144 mm, and the width of each of curved surface portions 121B located at both ends is 2 mm. Moreover, a bulging amount (H in FIG. 7) of the bottom surface of housing 120 is about 0.5 mm. Deformation line 122 has an arc shape determined by width A and bulging amount H. The width (A) of flat surface portion 121A is appropriately changed within a range of, for example, about 140 mm or more and 146 mm or less. On this occasion, the bulging amount (H) is, for example, about 0.3 mm or more and 1.0 mm or less.

As the width of heat transfer member 500 is wider, an amount of heat radiation from battery cell 100 can be larger. On the other hand, when the width of heat transfer member 500 is too wide, weight reduction of battery pack 1 and reduction in manufacturing cost of battery pack 1 can be inhibited.

Heat from electrode assembly 130 accommodated in housing 120 is dissipated from the bottom surface of housing 120. Electrode assembly 130 is provided to extend over the entire width of housing 120 in the X axis direction, but electrode assembly 130 and the bottom surface of housing 120 are stably in contact with each other within the range of flat surface portion 121A except for curved surface portions 121B. In the present example, since heat transfer member 500 is provided such that the edge ends of heat transfer member 500 and the edge ends of flat surface portion 121A substantially coincide with each other, the heat dissipation efficiency can be effectively improved without excessively increasing the width of heat transfer member 500.

Although the embodiments of the present invention have been described and illustrated in detail, it is clearly understood that the same is by way of illustration and example only and is not to be taken by way of limitation, the scope of the present invention being interpreted by the terms of the appended claims. The scope of the present invention is defined by the terms of the claims, and is intended to include any modifications within the scope and meaning equivalent to the terms of the claims.

What is claimed is:

1. A power storage device comprising:
a plurality of power storage cells each including a case having a substantially rectangular parallelepiped shape with a bottom surface, the plurality of power storage cells being stacked along a first direction;
a cooling plate provided on the bottom surface of the case in each of the plurality of power storage cells; and
a heat transfer member provided between the bottom surface of the case and the cooling plate, wherein
the cooling plate is provided with a recess along deformation of the bottom surface of the case in a second direction orthogonal to the first direction.

2. The power storage device according to claim 1, wherein in the second direction, an edge end of the recess of the cooling plate and an edge end of the heat transfer member substantially coincide with each other.

3. The power storage device according to claim 1, wherein
in a state in which the case is not deformed, the bottom surface includes a flat surface portion located on a central side in the second direction and curved surface portions located on both end sides in the second direction, and
in the second direction, an edge end of the flat surface portion and an edge end of the heat transfer member substantially coincide with each other.

4. The power storage device according to claim 1, wherein the cooling plate located outside the recess in the second direction has a flat surface.

5. The power storage device according to claim 1, wherein the cooling plate is located on a lower side with respect to an ideal line of the bottom surface of the case.

6. The power storage device according to claim 1, wherein the cooling plate has a protrusion protruding on an upper side with respect to an ideal line of the bottom surface of the case, and the heat transfer member extends to an outer side with respect to the protrusion in the second direction.

7. The power storage device according to claim 1, wherein the recess includes an arc shape in the second direction.

8. The power storage device according to claim 1, further comprising a low friction layer provided between the bottom surface of the case and the heat transfer member and having a relatively small friction coefficient.

9. The power storage device according to claim 1, further comprising a grip portion provided between the cooling plate and the heat transfer member to increase frictional resistance between the cooling plate and the heat transfer member.
